(19) United States
(12) Patent Application Publication
(10) Pub. No.: US 2016/0097861 A1
(43) Pub. Date: Apr. 7, 2016

(54) METHOD AND APPARATUS FOR LOCATION DETERMINATION

(71) Applicants: Xiang-Yang Li, Naperville, IL (US); Cheng Bo, Santa Clara, CA (US)

(72) Inventors: Xiang-Yang Li, Naperville, IL (US); Cheng Bo, Santa Clara, CA (US)

(73) Assignee: Illinois Institute of Technology, Chicago, IL (US)

(21) Appl. No.: 14/872,741

(22) Filed: Oct. 1, 2015

Related U.S. Application Data
(60) Provisional application No. 62/058,189, filed on Oct. 1, 2014.

(51) Int. Cl. G01S 19/47; G01S 19/26; G01S 19/52; H04W 4/02; G01S 19/23

(52) U.S. Cl. CPC G01S 19/47; H04W 4/02; G01S 19/235; G01S 19/52; G01S 19/26

(57) ABSTRACT

A method and apparatus, such as implemented by software code on a mobile device, to estimate a location and a traveling distance by leveraging lower-power inertial sensors embedded in the mobile device as a supplement to the device's GPS. To minimize the negative impact of sensor noises, the invention exploits intermittent strong GPS signals and uses linear regression to build a prediction model which is based on a trace estimated from inertial sensors and the one computed from the GPS. Additionally or alternatively, the invention can utilize landmarks (e.g., bridges, traffic lights, etc.) detected automatically and/or special driving patterns (e.g., turning, uphill, and downhill) from inertial sensory data to improve the localization accuracy when the GPS signal is weak.

### CROSS REFERENCE TO RELATED APPLICATION

This application claims the benefit of U.S. Provisional Patent Application, Ser. No. 62/058,189, filed on 1 Oct. 2015. The co-pending Provisional patent application is hereby incorporated by reference herein in its entirety and is made a part hereof, including but not limited to those portions winch specifically appear hereinafter.

### FIELD OF THE INVENTION

This invention, is related to location determination using mobile electronic devices, such as smart phones, and more particularly to determining location when Global Positioning Satellite (GPS) signals are absent or not accurate.

### BACKGROUND OF THE INVENTION

Current problem caused by weak GPS signal in metropolitan areas often lead to less than desirable user experiences. Comprehensive experiments in downtown Chicago have indicated that GPS signals are very weak and unstable on most roads due to high-rises, or even completely blocked, in some complicated road structures, such as tunnels and underground roadways. To handle such difficulties, existing technologies mainly focuses on using inertial sensors to measure walking speed and distance of a pedestrian and to exploit compass information to estimate direction, so as to estimate a location. Some utilize motion sensors to collect motion, data of vehicles, and use remote servers to calculate a position. However, the real-time localization of moving vehicles in metropolitan areas is far more challenging, as such activity does not have a cycle pattern in sensory data. In addition, the pattern of a moving vehicle is much more complicated, depending on the current driving condition and road infrastructures. Therefore, current technologies cannot transplant to locating moving vehicle in metropolises directly.

### SUMMARY OF THE INVENTION

The method and system of this invention provide more precise location positions for moving vehicles in metropolitan areas. The invention includes adjusting the location dynamically according to current driving status and road infrastructures. The invention can be designed as an application for a mobile device, sued as an. Android smartphone, which can be mounted to a windshield while driving.

Another potential use for the invention is to reduce the energy usage of of mobile device. Using GPS to obtain continuous location consumes large amount of battery energy. However, extracting sensory data to complement GPS positioning can reduce energy consumption without compromising the location accuracy.

The general object of the invention can be attained, at least in part, through a method for determining location, such as implemented via software executed on a mobile device. The method includes measuring movement of an electronic device with at least one inertial sensor of the electronic device. Exemplary inertial sensors include an accelerometer, a gyroscope, and/or a magnetic field sensor. The method further includes automatically calculating a moving velocity and/or a traveling distance of the electronic device as a function of the measured movement, and automatically determining an error value in the calculated moving velocity and/or traveling distance by comparison, of the calculated moving velocity and/or traveling distance to GPS signals, when available. Further calculations using sensor readings, such as when GPS signals are absent, or inaccurate, are improved by automatically compensating as a function of the error value.

In embodiments of this invention, an error value is determined from a comparison between a calculated moving velocity and/or traveling distance and a GPS-measured moving velocity and/or traveling distance for a same time and/or distance. The error value is determined when the GPS signal is available and is useful for increasing accuracy of the sensor-based estimation when the GPS signals are not accurate or available. Upon reestablishing an accurate GPS signal the error value is determined again for a further distance or time. In embodiments of this invention, the error value is continually determined in a “shifting window” of time and/or distance, such that the error value is more accurate to changes in location.

In embodiments of this invention, the movement of the electronic device is modeled as a summation of true movement and sensor error during a predetermined time period. During this time period, sensor error is determined by comparing the sensor measured device movement to GPS signals received, by the device. Continually remodeling for a predetermined time or distance occurs in the presence of the GPS signals, in view of, for example, changing road and/or traffic patterns. In one embodiment, the error value of the model is calculated using linear regression.

Embodiments of this invention additionally include calibration to electronic map data and/or traffic pattern (either real-time or historical). By detecting slowing, stopping, turning, and/or reacceleration, etc. with the inertial sensors, and analyzing and comparing these movement activities against a map, the location can be calibrated or otherwise fine-tuned to provide a more accurate location, particularly in the absence of GPS signals. For example, acceleration, stopping, and/or turning can be automatically correlated to map data, such as an intersection location, to calibrate or correct a location determination.

Another embodiment of this invention includes a method for determining location by sensing movement of an electronic device with at least one inertial sensor of the electronic device during a predetermined timeframe in a presence of GPS signals, automatically calculating a moving velocity and/or a traveling distance of the electronic device as a function of the measured movement, automatically determining an error value in the calculated moving velocity and/or traveling distance by comparison with the GPS signals, sensing further movement, off an electronic device with at least one sensor of the electronic device in an absence of the GPS signals, and automatically calculating a former moving velocity and/or a further traveling distance of the electronic device in the absence of the GPS signals by compensating the further measured movement as a function of the error value. The error value is continually redetermined during movement of the electronic device in the presence of the GPS signals. The error value used to calculate the further velocity and/or a further traveling distance of the electronic device is desirably determined from a predetermined period prior to loss of the GPS signals.

The method and model of this invention can also be used to correct a location determined from weak and/or inaccurate GPS signals as a function of the inertia sensor-based calculated moving velocity and/or traveling distance of the electronic device.

The method embodiments described above are implemented automatically through software code stored on a recordable medium and executed by a processor on an electronic device used to determine and track location. The invention includes a portable electronic device and/or navigation system including one or more processors, an inertial sensor, a GPS antenna, memory, and one or more programs or applications stored in the memory and configured to be executed by the one or more processors. The one or more programs include instructions for measuring a movement of an electronic device with the inertial sensor, instructions for calculating a moving velocity and/or a traveling distance of the electronic device as a function of the measured movement, instructions for determining an error value in the calculated moving velocity and/or traveling distance by comparing with obtained. GPS position data, and instructions for determining a further moving velocity and/or a further traveling distance of the electronic device as a function of a further measured movement and the error value in absence of a GPS signal.

The invention further includes or Is implemented by a non-transitory computer-readable storage medium encoded with instructions for determining a location of a portable electronic device with an inertial sensor and a GPS antenna. The encoded instructions include instructions for measuring a movement of an electronic device with the inertial sensor, instructions for calculating a moving velocity and/or a traveling distance of the electronic device as a function of the measured movement, instructions for determining an error value in the calculated moving velocity and/or traveling distance by comparing with obtained GPS position data; and instructions for determining a further moving velocity and/or a further traveling distance of the electronic device as a function of a former measured movement and the error value in absence of a GPS signal.

### BRIEF DESCRIPTION OF THE DRAWINGS

FIG. 1 shows a non-scaled, representative city area for illustration purposes.

FIG. 2 shows patterns of sensor data collected in different road infrastructures when driving: (a) car stopping and crossing a traffic light; (b)-(d) car turning 90 degrees; and (e) car crossing a bridge, according to one embodiment of this invention.

FIG. 3 shows patterns of sensor data for a car turning and changing lanes, according to one embodiment of this invention.

### DESCRIPTION OF THE INVENTION

This invention includes a localization method and system to estimate a location and a traveling distance, particularly for use areas with blocked GPS signals, such as in metropolitan areas, by leveraging low-power inertial sensors as a supplement to GPS. Embodiments of this invention include a new dynamic trajectory model for automatically calculating trajectory distance and the location or a moving vehicle in metropolitan areas based upon current road conditions. The invention can also incorporate a calibration strategy based on road infrastructures and driving status to adjust the positioning accuracy.

In embodiments of this invention, inertial sensors in the mobile device are used to estimate the movement of a vehicle, and provide locations based on the traveling distance and orientation with high accuracy bat low energy consumption. The invention addresses the inaccuracy caused by complex infrastructures in, for example, downtown areas, and can also exploit area landmarks in the map to improve the localization accuracy.

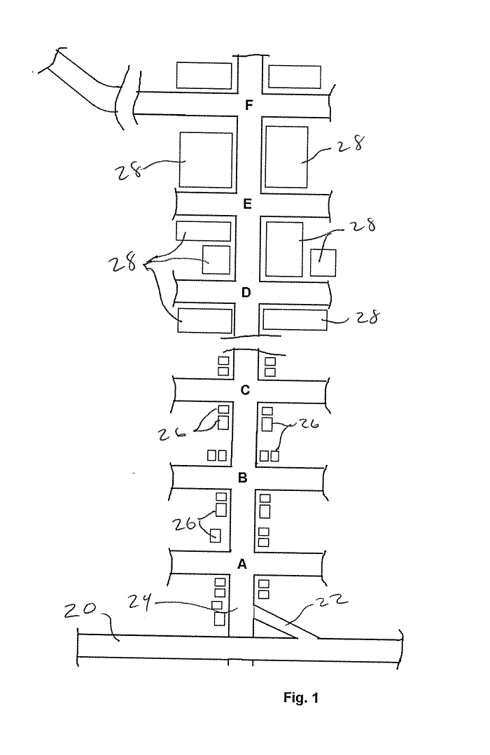

FIG. 1 shows a non-scaled, representative city area for illustration purposes. Referring to FIG. 1, a car (not shown) is traveling on highway 20 using a smartphone for directions to a destination. The smartphone uses a GPS antenna in combination with an electronic map, as is well, known in the art, to show the driver location on the displayed map and provide directions to the destination. On highway 20, the GPS signal is strong. The driver exits on ramp 22 and drives along city road 24 until reaching intersection F, at which time the driver turns left, according to the directions. While driving through intersections A-C, the driver is among smaller sized buildings 26 and still can receive GPS signals. However, upon reaching a downtown area including intersections D-F, the tali buildings 28 interfere with the GPS signals and the smartphone loses the GPS signal and cannot determine the car location.

Tire method and software application of this invention are useful to provide car location upon the GPS signal being lost between the tall downtown buildings 28, or airy other environment that interferes with receiving GPS signals. While receiving GPS signals, along highway 20 and through intersections A-C, the phone operates according to this invention to use the phone's inertial sensors to continually estimate the movement and/or location of the vehicle. The estimated movement and/or location is compared to the GPS-determined location to determine an error value of the inertial sensor-based estimation. Referring again to FIG. 1 when the GPS signals are lost. In the area of intersections D-F, the estimation model provided by this invention, can be used to determine the vehicle location through intersections D-F. For example, the device accelerometer can determine the acceleration and stopping at (are or more of the intersections D-F and the gyroscope can be used to determine any turn, such as the left turn at intersection F.

As stated above, the method continually models the sensor readings to estimate location and to determine the error value against the GPS. However, referring to FIG. 1, a model based upon travel through intersections A-C would more accurately reflect Intersections D-F than a model influenced by travel on highway 20. Therefore, in embodiments of this invention the model is embodied as a shifting window that updates or reestablishes using recent sensor readings. The window can be established by a predetermined time (e.g., 1 or 2 minutes, etc.) or distance (e.g., 0.5 miles, 1 mile, etc.), and can be rigid or flexible, such as responding to obvious changes in road type (e.g., highway to city travel). Once the GPS signal is reacquired, such, as after leaving the downtown area, the model is updated by new sensor/GPS location comparison and the error value is updated or refreshed.

Although existing works use accelerometer, gyroscope, and/or magnetometer sensors to calculate motion conditions, the intrinsic noise can make the naive distance estimation based on Newton's Law unavailable because the error would be accumulated. In embodiments of this invention, a predictive dynamic trajectory estimating model adaptively calibrates itself using GPS signals and dead-reckoning.

a. Velocity Estimator:

Because of the inertial noises and measurement errors, the traditional velocity estimation model is no longer reliable. The velocity Vᵢ, at the end of a timeslot i can be denoted as:

Vᵢ=Vᵢ₋₁+β·aᵢ·Δt+μ,

where β is the parameter to be learned and adjusted in real time, aᵢ is the average measured acceleration during the timeslot i, and μ is the noise.

When the GPS signals are strong, both Vᵢ and Vᵢ₋₁ can be achieved from GPS directly, and the mean, linear acceleration aᵢ is extracted from the accelerometer. The best parameter of β and μ can be calculated through regression of the model. When the localization through GPS is unreliable, the trained model predicts the velocity Vᵢ.

b. Distance Estimator:

For general working cases, the trajectory distance gathered from GPS indicates the distance with some error. Therefore, G(Δtᵢ) is denoted as the distance daring a timeslot i read from GPS, which can also be presented as:

G(Δtᵢ)=λ₁·Vᵢ₋₁·Δt+1/2·âᵢ·Δt²+η,

where âᵢ is the actual acceleration in the timeslot i. In this equation, λ₁ is multiplied to reflect the error in the estimated speed Vᵢ₋₁ for the time slot i−1. Since the known measured acceleration aᵢ contains both inherent noise and measurement error, by assuming that these errors follows normal, distribution, the measured acceleration can be defined, as aᵢ+(1+ε)âᵢ+δ.

The distance can then be calculated by the following formula:

G(Δtᵢ)=λ₁·Vᵢ₋₁·Δt+λ₂·1/2·aᵢ·Δt²+λ₃·Δt²+λ₄·Δt+η.

where λ₁ to λ₄ are parameters to be learned by the regression model. When the GPS signals are strong (e.g., GPS error is less than 20 meters), based on the Vᵢ₋₁, aᵢ is computed using the sensory data and the distance from GPS. The previous equation is used as a model to predict the distance in time slot i when GPS signals are bad. From the predicted trajectory distance G(Δtᵢ), the location at the timeslot i can be estimated based on the obtained location, distance and orientation.

Driving in metropolitan areas provides other unpredictable traffic conditions and road infrastructures, such as tunnels, bridges, traffic lights, and crossroads, which will affect the parameters learnt from the previous model. Therefore, a more flexible dynamic adjusting strategy is provided to update the parameters to match the current driving status. In this strategy, parameters are calculated in a predictive dynamic trajectory estimating model only based on the latest driving data. A small buffer can be allocated to save the latest driving information. When the protocol is still in the learning process, the model will replace the oldest data with latest information in order to update the model parameters.

### Movement Detection:

Existing works do not take the driving conditions into account, for example, if the vehicle stops, the estimated speed, is highly likely to be non-zero, which leads to a huge error in the final prediction. Embodiments of this invention can incorporate a landmark or map-based calibration to adjust the location when the vehicle stops.

a. Traffic Lights:

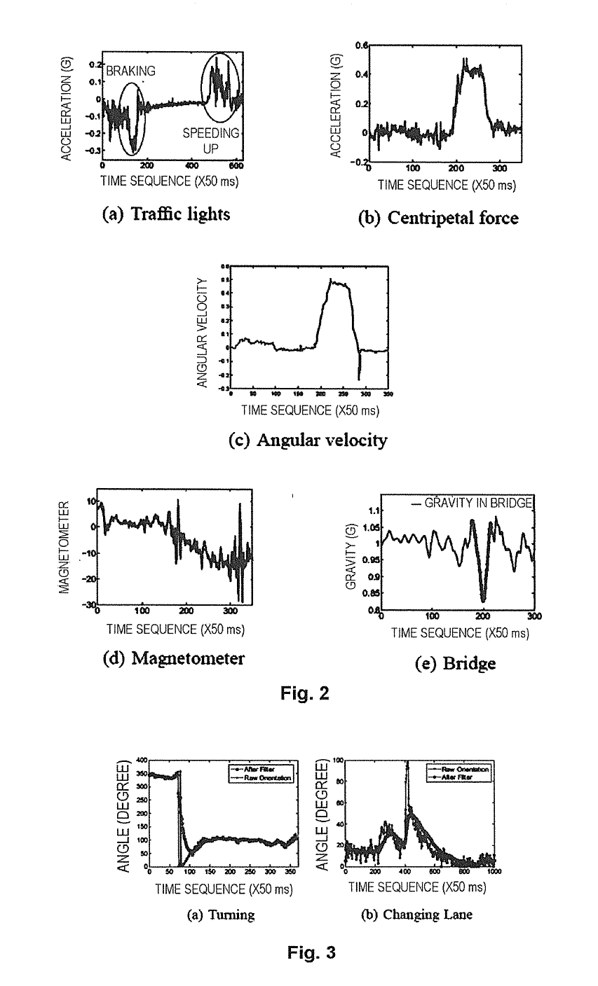

When a vehicle stops due to the traffic lights and/or drives through crossroads, unique patterns appear in the readings of sensors (See FIG. 2(a)). The acceleration falls below zero when the vehicle brakes, reaching the lowest point at the very moment when the vehicle stops, and gets back to zero swiftly. However, sometimes the vehicle may stop with a certain distance from the crossroad. One approach adopted in this invention is to subtract

$$\frac{n \cdot L}{2} ,$$

where L indicates me average length of a vehicle, and n represents the current possible number of vehicles waiting for a signal change (e.g., a green light). The number of vehicles waiting for green lights can be assumed to follow a normal distribution of n□N(μᵢ,σᵢ²).

b. Turning:

The orientation of a moving vehicle can be determined by an angle change, which is observed along the axis in gravity direction. The readings 0, 90, 180, and 270 can represent north, east, south, and west, respectively. Embodiments of the invention, employ moving averages to cancel some noises and calculate the driving orientation.

FIG. 2(b) shows centripetal, force sensed by an accelerometer, and the scale of the acceleration depends on the speed at which the vehicle is turning. Simultaneously, the angular velocity sensed by the gyroscope also reaches up to 0.5 rad/s in a test case (FIG. 2(e)), and the data from the magnetometer changes as well with a large fluctuation. Finally, the orientation of the smartphone also changes approximately 90 degrees when turning left or right. Although the angle may not be accurate enough due to the large noise in the magnetometer (the maximum error experienced was approximately 30°), the system is still able to correctly determine the road segment to which the car is turning by calibration. FIG. 3(a) shows a case when a vehicle turns from the north, the angle is from about 350° to 100°, which is east. FIG. 3(b) shows a comparison of the measured angle difference for turning and lane changing, as lane changing cart be wrongly detected as a turning. The angle difference when a ear changes its lane is much smaller than the one when a car makes a turn.

Certain driving patterns, such as turning left or right and stopping for traffic lights or stop signs, can be more accurately detected and thus classified. To classify other road infrastructures, the sensor readings of those patterns are collected and stored as fingerprints, and then match the real-time sensor readings with the trained fingerprints. The invention can rely on coarse-grained estimation of the location from dead-reckoning first, and then use a predictive regression model to confine the search space: only the road infrastructures (stored fingerprints) I within a certain distance δ from the estimated location x will be considered as the matching candidate for the real dime pattern P achieved from the sensory data. The infrastructure that maximizes the weighted matching score:

αM(I,P)+(1−α)e^{-D(x,L(I))},

where M(I,P) is the matching score between the fingerprint of an infrastructure I and the observed pattern P, αε(0,1) is a constant, and D(x,L(I)) is the geodesic distance between the location x and the location L(I) of infrastructure I. Then, the estimated location x is updated as the location L(I*) of the infrastructure I* which maximizes the weighted matching score.

The invention is desirably designed as a software application, running on a mobile computing device, such as an Android smartphone. For testing, the invention was deployed in a Samsung Galaxy S3, with Android 4.3, and an extensive evaluation was taken in both downtown Chicago and suburban highways. During the experiments, the smartphone was mounted to the windshield, and the invention took, over 100 different road segments in downtown Chicago ranging from 1 km to 1.0 km, and over 30 km on the highway.

The test system calibrated the location as soon as it detected specific patterns. In order to compare the results to the ground truth, the evaluation was conducted on the road with good GPS locations. In this case, the GPS location was considered as ground truth. In the evaluation, it was assumed that part of the road did not have GPS signals, and the location in this segment of roads was calculated and the result compared to the original GPS locations, in the first evaluation, the first 3400 m was with reliable GPS signals, and the precise locations were accessible. The location accuracy was tested in the following 1400 m. During the experiment, the vehicle crossed 5 traffic lights in total, and successfully detected all 5 traffic lights. For the first 900 m, the estimation trace nearly overlapped with the ground truth. During the whole test, although the predicted distance consequently deviated from the ground truth a little, the error remained small.

The deviation of the results from the ground truth came from the accumulated error from all time slots. With landmarks calibration as described herein, the mean error of the estimated locations for all time slots fell below 20 m for 90% of time.

On the highway, the tests were taken under 10 different highway segments with total distance being over 60 km. The precise location from the GPS was updated every 3 seconds. For each segment, the first 3 km was trained and the location was predicted for the next 2 km. The experiments indicated that the largest error was only 12 m among the 10 different highway segments, and in over 80% of the cases, the errors were less than 5 m. Compared with the actual distance extracted from the ground truth, at over 95% locations, the errors were less that 1% of the actual driving distance, and the largest error was less than 2% of the actual driving distance. The experiments also demonstrated mat the accuracy of the prediction decreased with the increase of the driving distance.

Thus, the invention provides a method and apparatus for determining location, and for supplementing GPS locations when signals are lost and/or for correcting inaccurate GPS locations.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from me novel teachings and advantages of this invention. Accordingly, all such modifications are intended to be included within, the scope of this invention, which is defined, in file following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A method for determining location, the method comprising:
measuring movement of an electronic device with at least one inertial sensor of the electronic device;
automatically calculating a moving velocity and/or a traveling distance of the electronic device as a function of the measured movement;
automatically determining an error value in the calculated moving velocity and/or traveling distance by comparison of the calculated moving velocity and/or traveling distance to GPS signals; and
automatically compensating further calculations of a further moving velocity and/or a further traveling distance using the at least one inertial sensors as a function of the error value.

2. The method of claim 1, wherein the at least one inertial sensor is selected from an accelerometer, a gyroscope, and/or a magnetic field sensor.

3. The method of claim 1, wherein the further calculations of moving velocity and/or a traveling distance of the electronic device occurs in absence of any or accurate GPS signals.

4. The method of claim 3, further comprising determining a second error value for a predetermined time or travel distance upon reestablishing the GPS signals.

5. The method of claim 1, further comprising determining the error value from a comparison between the calculated moving velocity and/or traveling distance and a GPS-measured moving velocity and/or traveling distance for a same time and/or distance.

6. The method of claim 1, further comprising modeling the movement of the electronic device as a summation of true movement and sensor error during a predetermined time period, wherein sensor error is determined by comparing the sensor measured movement to obtained GPS signals, and continually remodeling for a predetermined time or distance in the presence of the GPS signals.

7. The method of claim 6, further comprising calculating the error value using linear regression.

8. The method of claim 1, further comprising automatically calibrating a determined location of the electronic device upon slowing, stopping, and/or reacceleration by comparing an estimated location to predetermined traffic data and/or an electronic map.

9. The method of claim 8, wherein the predetermined traffic data comprises real-time data or time-based data.

10. The method of claim 1, further comprising automatically calibrating the acceleration and/or stopping of the electronic device to map data.

11. The method of claim 10, further comprising coordinating or matching sensor readings with an electronic map.

12. A method for determining location, the method comprising:
sensing movement of an electronic device with at least one inertial sensor of the electronic device during a predetermined timeframe in a presence of GPS signals;
automatically calculating a moving velocity and/or a traveling distance of the electronic device as a function of the measured movement;
automatically determining an error value in the calculated moving velocity and/or traveling distance by comparison with the GPS signals;
sensing further movement of an electronic device with at least one sensor of the electronic device in an absence of the GPS signals; and
automatically calculating a further moving velocity and/or a further traveling distance of the electronic device in the absence of the GPS signals by compensating the further measured acceleration as a function of the error value.

13. The method of claim 12, wherein the error value is continually redetermined during movement of the electronic device in the presence of the GPS signals.

14. The method of claim 13, wherein the error value used in calculating the former velocity and/or a further traveling distance of the electronic device is determined horn a predetermined period prior to loss of the GPS signals.

15. The method of claim 12, further comprising correcting a location determined from the GPS signals as a function of the calculated moving velocity and/or traveling distance of the electronic device.

16. The method of claim 12, wherein the at least one inertial sensor is selected from an accelerometer, a gyroscope, and/or a magnetic field sensor.

17. A portable electronic device, comprising:
one or more processors;
an inertial sensor;
a global positioning satellite (GPS) antenna;
memory; and
one or more programs, wherein the one or more programs are stored in the memory and configured to be executed by the one or more processors, the one or more programs including:
instructions for measuring a movement of an electronic device with the inertial sensor;
instructions for calculating a moving velocity and/or a traveling distance of the electronic device as a function of the measured movement;
instructions for determining an error value in the calculated moving velocity and/or traveling distance by comparing with obtained GPS position data; and
instructions for determining a further moving velocity and/or a further traveling distance of the electronic device as a function of a further measured movement and the error value in absence of a GPS signal.

18. The method of claim 17, wherein the inertial sensor is selected from an accelerometer a gyroscope, and/or a magnetic field sensor.

19. A non-transitory computer-readable storage medium encoded with instructions for determining a location of a portable electronic device with an inertial sensor and a global positioning satellite (GPS) antenna, the encoded instructions comprising:
instructions for measuring a movement of an electronic device with the inertial sensor;
instructions for calculating a moving velocity and/or a traveling distance of the electronic device as a function of the measured movement;
instructions for determining an error value in the calculated moving velocity and/or traveling distance by comparing with obtained GPS position data; and
instructions for determining a further moving velocity and/or a further traveling distance of the electronic device as a function of a further measured movement and the error value in absence of a GPS signal.

20. A navigation system comprising:
an electronic device comprised of one or more processors, an inertial sensor, a global positioning satellite (GPS) antenna, a non-transitory memory component; and
one or more programs, wherein the one or more programs are stored in the memory component and configured to be executed by the one or more processors, the one or more programs including:
instructions for measuring a movement of an electronic device with the inertial sensor;
instructions for calculating a moving velocity and/or a traveling distance of the electronic device as a function of the measured movement;
instructions for determining an error value in the calculated moving velocity and/or traveling distance by comparing with obtained GPS position data; and
instructions for determining a further moving velocity and/or a further traveling distance of the electronic device as a function of a further measured movement and the error value in absence of a GPS signal.
